(19) United States
(12) Patent Application Publication
(10) Pub. No.: US 2022/0344888 A1
(43) Pub. Date: Oct. 27, 2022

(54) AMPLIFICATION FIBER AND OPTICAL AMPLIFIER

(71) Applicant: NIPPON TELEGRAPH AND TELEPHONE CORPORATION, Tokyo (JP)

(72) Inventors: Shinichi AOZASA, Musashino-shi, Tokyo (JP); Taiji SAKAMOTO, Musashino-shi, Tokyo (JP); Kazuhide NAKAJIMA, Musashino-shi, Tokyo (JP); Masaki WADA, Musashino-shi, Tokyo (JP)

(73) Assignee: NIPPON TELEGRAPH AND TELEPHONE CORPORATION, Tokyo (JP)

(21) Appl. No.: 17/762,403

(22) PCT Filed: Sep. 26, 2019
(86) PCT No.: PCT/JP2019/037913

§ 371 Date: Mar. 22, 2022

(51) Int. Cl. H01S 3/067

(52) U.S. Cl. CPC H01S 3/06758; H01S 3/06708

(57) ABSTRACT

An objective of the present invention is to provide an amplification fiber having a cladding excitation configuration that improves amplification efficiency and an optical amplifier. An amplification fiber (10) according to the present invention is a multi-core amplification fiber having, from one end (E1) to the other end (EE), a plurality of cores (11b) in a cladding (11a), and a total distance from the one end (E1) to the other end (EE) in which rare earth ions are doped differs depending on the types of cores (11b). The cores (11b) are preferably disposed such that the cores of the same type are not adjacent to each other. By arranging the types of the cores in this manner, requirements for inter-core crosstalk can be mitigated since the bands of signal light in the adjacent cores are different. As a result, a density of cladding excitation light can be increased by shortening the inter-core distance, and thus the amplification efficiency can be improved.

### TECHNICAL FIELD

The present disclosure relates to an optical amplifier disposed in an optical communication system using spatially multiplexing (multi-core or multi-mode) optical fibers and an amplification fiber provided in the optical amplifier.

### BACKGROUND ART

Optical amplifiers for amplifying an optical signal as it is without converting the optical signal into an electrical signal in an optical communication system with single-mode optical fibers have been put into practical use. Spatially multiplexing optical amplifiers are also expected to be used for optical communication systems using spatially multiplexing optical fibers (for example, see NPL 1).

For spatially multiplexing optical amplifiers, a configuration in which excitation light beams are individually supplied to a core for amplification (a core excitation configuration) and a configuration in which excitation light beams are supplied to a cladding (a cladding excitation configuration) are known. The cladding excitation configuration can simultaneously amplify a plurality of spatial channels propagating within the cladding and can be simplified compared to the core excitation configuration. Furthermore, the cladding excitation configuration is expected to reduce power consumption compared to a configuration in which optical amplifiers for core excitation are used for the number of spatial channels (for example, see NPL 2). In addition, the cladding excitation configuration can use a multi-mode laser diode (LD) as a light source and thus can increase photoelectric conversion efficiency compared to the core excitation configuration that needs to use a single-mode LD as a light source.

### CITATION LIST

### Non Patent Literature

NPL 1: M. Wada et al., “Recent Progress on SDM Amplifiers”, We1E. 3, Proc. ECOC, (2018).
NPL 2. S. Jain et al., “32-core Erbium/Ytterbium Doped Multi-Core Fiber Amplifier for Next Generation Space-Division Multiplexed Transmission System”, Optics Express, 25 (26). (2017).
NPL 3: H. Ono et al., “1.58 μm band Gain-Flattened Erbium-Doped Fiber Amplifiers for WDM transmission Systems”. Journal of Lightwave Technology, vol. 17, No. 3 490-496, (1999).

### SUMMARY OF THE INVENTION

### Technical Problem

However, the cladding excitation configuration has a problem that amplification efficiency is inferior to that of the core excitation configuration because, of excitation light incident on the cladding, light beams that have not been coupled to the core are not used for amplification of optical signals.

Therefore, in order to solve the problem described above, an object of the present invention is to provide an amplification fiber with a cladding excitation configuration that improves amplification efficiency, and an optical amplifier.

### Means for Solving the Problem

In order to achieve the above objective, in the amplification fiber according to the present invention, the amplification fiber is lengthened to the extent that a desired amplification rate is obtained, and the distance of a core to which rare earth ions are added can vary according to the band of signal light propagating through the core.

Specifically, an amplification fiber according to the present invention is a multi-core amplification fiber having a plurality of cores in a cladding from one end to the other end, and a total distance from the one end to the other end in which rare earth ions are doped varies according to the type of each core.

By lengthening the present amplification fiber, excitation light incident on the cladding can increase an amount of light coupled to the core and thus amplification efficiency is improved. In addition, a distance of each core into which rare earth ions are doped to obtain a desired amplification rate varies according to each band of signal light. For this reason, in the case where bands of signal light are different for each core, the total distance in cores into which rare earth ions are doped is varied for each band.

Thus, the present invention can provide an amplification fiber with a cladding excitation configuration that improves the amplification efficiency.

The amplification fiber according to the present invention may have a section between the one end and the other end in which all of the cores are not doped with rare earth ions. Sections in which the rare earth ions are doped may be discontinuous.

The refractive index distribution on across section of the amplification fiber according to the present invention may be different for the type of core.

In the cross section of a section in which rare earth ions are doped to all of the cores of the amplification fiber according to the present invention, the concentration distribution of the rare earth ions may be different for the type of core.

The cores of the amplification fiber according to the present invention are preferably disposed such that cores of the same type are not adjacent to each other. Because signal light having different bands propagates to adjacent cores, requirements for inter-core crosstalk can be mitigated, and the cores can be brought close to each other. In other words, a density of excitation light of the cladding can be increased, and thus amplification efficiency is improved.

An optical amplifier according to the present invention includes the amplification fiber and a light incidence part configured to cause excitation light to be incident on the cladding of the amplification fiber, and cause signal light to be incident on the core of the amplification fiber. The light incidence part causes the signal light to be incident on the core of a different type for each band.

The present invention can provide an optical amplifier having a cladding excitation configuration that improves amplification efficiency since the amplification fiber is provided.

The amplification fiber of the optical amplifier according to the present invention may propagate the signal light in multi-mode.

Note that each of the inventions described above can be combined with the others to the extent possible.

### Effects of the Invention

The present invention can provide an amplification fiber having a cladding excitation configuration that improves amplification efficiency and an optical amplifier.

### BRIEF DESCRIPTION OF DRAWINGS

FIG. 1 is a diagram illustrating an amplification fiber according to the present invention.

FIG. 2 is diagrams illustrating cross sections of the amplification fiber according to the present invention.

FIG. 3 is a diagram illustrating an optical amplifier according to the present invention.

### DESCRIPTION OF EMBODIMENTS

Embodiments of the present invention will be described with reference to the accompanying drawings. The embodiments described below are examples of the present invention and the present invention is not limited to the embodiments described below. Note that components with the same reference signs in the specification and the drawings are assumed to be the same components.

### First Embodiment

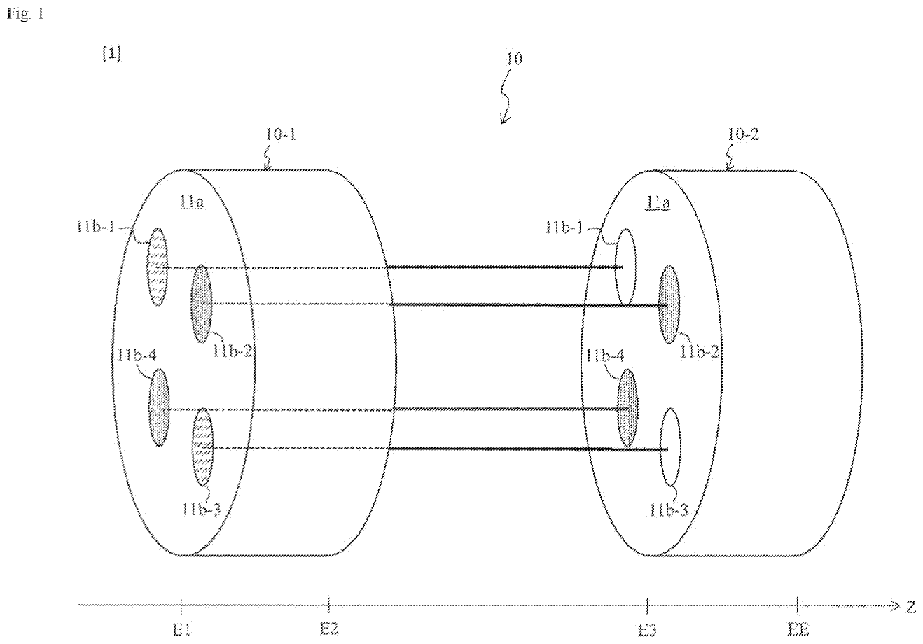

FIG. 1 is a diagram illustrating an amplification fiber 10 according to the present embodiment. The amplification fiber 10 is a multi-core amplification fiber having a plurality of cores 11b in a cladding 11a from one end E1 to the other end EE, and a total distance from the one end E1 to the other end EE in which rare earth ions are doped differs depending on the type of cores 11b.

In FIG. 1, the amplification fiber 10 has four cores (11b-1 to 11b-4). Note that the number of cores is not limited to four. The cores of the amplification fiber 10 are classified into two types. One type includes the core 11b-1 and the core 11b-3, and the other type includes the core 11b-2 and the core 11b-4. Note that the number of types of the cores is not limited to two.

The amplification fiber 10 includes a first amplification fiber 10-1 and a second amplification fiber 10-2. The first amplification fiber 10-1 has a predetermined length (for example, 15 m) from the one end E1. Here, when it is assumed that the longitudinal direction of the amplification fiber 10 is a Z direction, the first amplification fiber 10-1 corresponds to a section from Z=E1 to Z=E2. The second amplification fiber 10-2 has a predetermined length (for example, 10 m) from the other end EE. When expressed on a Z axis, the second amplification fiber 10-2 corresponds to a section from Z=E3 to Z=EE. Note that the lengths of the amplification fibers are examples.

The four cores (11b-1 to 11b-4) are doped with rare earth ions. The rare earth ions are, for example, erbium ions. Note that rare earth ions to be doped are not limited to erbium ions. However, in the cores 11b-2 and the cores 11b-4, both the first amplification fiber 10-1 and the second amplification fiber 10-2 are doped with rare earth ions, but in the core 11b-1 and the core 11b-3, only the first amplification fiber 10-1 is doped with rare earth ions.

In FIG. 1, between the one end E1 and the other end EE, there is a section (section from Z=E2 to Z=E3) in which all of the cores 11b are not doped with rare earth ions. This section is connected by a multi-core fiber (not illustrated) having the same structure as the first amplification fiber 10-1 and the second amplification fiber 10-2. Here, the structure includes a cladding diameter, a core diameter, the number of cores, core disposition, and a core refractive index distribution. For example, signal light incident on the core 11b-1 at the one end E1 is incident on a core corresponding to the core 11b-1 of the multi-core fiber from the core 11b-1 of the first amplification fiber 10-1, and is further incident on the core 11b-1 of the second amplification fiber 10-2 from the multi-core fiber. The same applies to the other cores.

Note that the first amplification fiber 10-1 and the second amplification fiber 10-2 may be directly connected without the multi-core fiber (that is, Z=E2=E3). Because the number of connection points of the optical fibers is reduced, loss resulting from connection can be reduced.

In other words, between the one end E1 and the other end EE, the distance of a section to which rare earth ions are doped differs depending on the type of cores 11b of the amplification fiber 10. For example, in the core 11b-1 and the core 11b-3, only the section corresponding to the first amplification fiber 10-1 (Z=E1 to Z=E2) is doped with rare earth ions, and the total distance of sections in which the rare earth ions are doped is approximately 15 m. On the other hand, in the core 11b-2 and the core 11b-4, the sections corresponding to the first amplification fiber 10-1 (Z=E1 to Z=E2) and the second amplification fiber 10-2 (Z=E3 to Z=EE) are doped with rare earth ions, and the total distance of the sections in which the rare earth ions are doped is approximately 25 m. Thus, signal light propagating in the core 11b-1 and the core 11b-3 is amplified only in the section of the first amplification fiber 10-1, and signal light propagating in the core 11b-2 and the core 11b-4 is amplified in the sections of the first amplification fiber 10-1 and the second amplification fiber 10-2.

For amplifying L-band (1565 to 1625 nm) signal light generally using an erbium-doped fiber (EDF) with the same amplification rate as C-band (1530 to 1565 nm) optical signal, an EDF that is several times longer than the EDF used in the C-band is required. If the amplification fiber 10 is used, by propagating the C-band optical signal in the cores 11b-1 and 11b-3 and propagating the L-band signal light in the cores 11b-2 and 11b-4, the signal light of both bands can be amplified with excitation light of the cladding 11a at a uniform amplification rate.

Note that a parameter for adjusting an amplification rate can be adjusted not only using a total distance of sections in which rare earth ions are doped in the cores but also a refractive index distribution of the cores or a concentration distribution of rare earth ions on the cross section.

### Second Embodiment

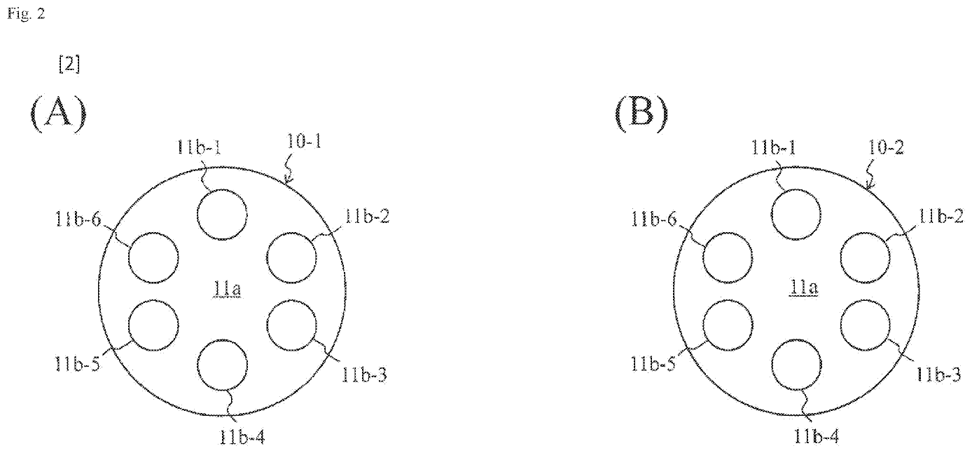

FIG. 2 is cross sectional diagrams illustrating the amplification fiber 10 according to the present embodiment. The amplification fiber 10 of the present embodiment is a 6-core amplification fiber. FIG. 2(A) illustrates the first amplification fiber 10-1, and FIG. 2(B) illustrates the second amplification fiber 10-2. Although the cores (11b-1, 11b-3, and 11b-5) of the first amplification fiber 10-1 are doped with rare earth ions, the cores (11b-1, 11b-3, and 11b-5) of the second amplification fiber 10-2 are not doped. On the other hand, the cores (11b-2, 11b-4, and 11b-6) of the first amplification fiber 10-1 as well as the second amplification fiber 10-2 are doped with rare earth ions.

In other words, by propagating a C-band optical signal in the cores (11b-1, 11b-3, and 11b-5) and propagating L-band signal light in the cores (11b-2, 11b-4, and 11b-6), the signal light of both bands can be amplified with excitation light of the cladding 11a at a uniform amplification rate.

Note that, in a case in which the cores (11b-1, 11b-3, and 11b-5) are set as cores of a first type and the cores (11b-2, 11b-4, and 11b-6) are set as cores of a second type, the cores 11b are preferably disposed such that the cores of the same type are not adjacent to each other. By arranging the types of the cores in this manner, requirements for inter-core crosstalk can be mitigated since the bands of signal light in the adjacent cores are different. As a result, a density of cladding excitation light can be increased by shortening the inter-core distance, and thus amplification efficiency can be improved.

### Third Embodiment

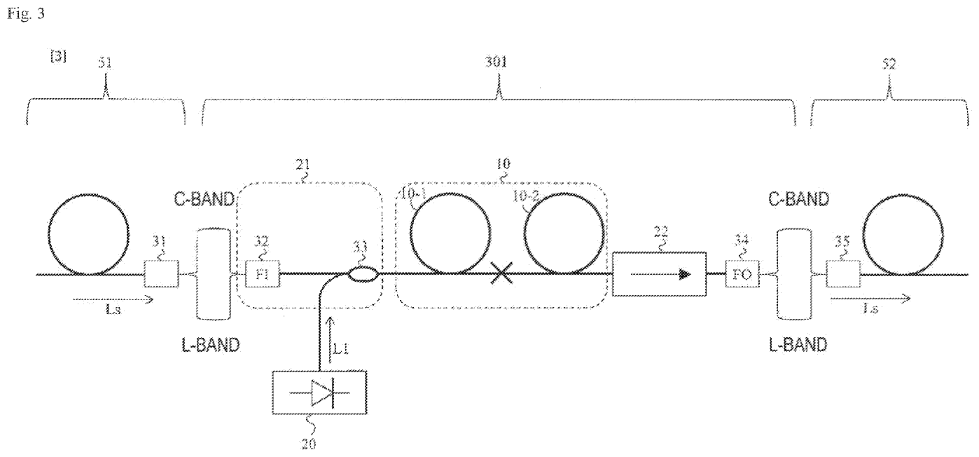

FIG. 3 is a diagram illustrating an optical amplifier 301 according to the present embodiment. The optical amplifier 301 includes the amplification fiber 10 described in the first embodiment or the second embodiment, and a light incidence part 21 that causes excitation light L1 to be incident on the cladding 11a of the amplification fiber 10 and causes signal light Ls to be incident on a core 11b of the amplification fiber 10, and the light incidence part 21 causes the signal light Ls to be incident on the core 11b of a different type for each band.

The optical amplifier 301 includes an excitation light source 20 that generates the excitation light L1, the light incidence part 21, an amplification fiber 10, and an isolator 22. The optical amplifier 301 is disposed between a wavelength multiplexing optical transmission line 51 and optical transmission line 52. The wavelength multiplexed signal light Ls propagating on the optical transmission line 51 is demultiplexed by a band multiplexer/demultiplexer 31 to each of wavelength bands. In the present embodiment, the band multiplexer/demultiplexer 31 separates the signal light Ls into two bands including a C band and an L band. A fan-in (FI) 32 of the light incidence part 21 causes the signal light Ls of the C and L bands to be incident on each core of the multi-core fiber. For example, the FI 32 causes the C-band signal light Ls to be incident on the cores of the multi-core fiber corresponding to the cores (11b-1 and 11b-3) and the L-band signal light Ls to be incident on the cores of the multi-core fiber corresponding to the cores (11b-2 and 11b-4) as described with reference to FIG. 1.

The excitation light source 20 is, for example, a multi-mode LD that outputs the excitation light L1 (for example, having a wavelength of 0.92 μm) in multi-mode. A multiplexer 33 of the light incidence part 21 causes the signal light Ls at each core of the multi-core fiber to be incident on each core 11b of the amplification fiber 10 and the excitation light L1 from the excitation light source 20 to be incident on the cladding 11a of the amplification fiber 10. Specifically, the C-band signal light Ls is incident on the cores (11b-1 and 11b-3) of the first amplification fiber 10-1, and the L-band signal light Ls is incident on the cores (11b-2 and 11b-4) of the first amplification fiber 10-1.

The amplification fiber 10 includes the first amplification fiber 10-1 in which the C-band and L-band amplification cores are alternately disposed and a second amplification fiber 10-2 in which L-band amplification cores and non-amplification cores are alternately disposed as described with reference to FIG. 1. The amplification fiber 10 amplifies the signal light Ls at each core 11b when the excitation light L1 is coupled with the core 11b from the cladding 11a.

As described above, for amplifying L band requires an EDF that is several times longer than the EDF used for amplifying the C band. For this reason, the second amplification fiber 10-2 in which only the cores (11b-2 and 11b-4) are doped with rare earth ions (the other cores are not doped) is connected subsequent to the first amplification fiber 10-1 to obtain sufficient gain in the L band. That is, as illustrated in FIG. 1, while in the second amplification fiber 10-2, the cores (11b-2 and 11b-4) through which the L-band signal light Ls propagates are doped with rare earth ions for amplification, the cores (11b-1 and 11b-3) through which the C-band signal light Ls propagates are not doped with rare earth ions since the C-band signal light Ls has obtained a sufficiently gain in the first amplification fiber 10-1.

The second amplification fiber 10-2 can utilize the remaining excitation light L1 from the first amplification fiber 10-1 as it is for amplification of the L band. The optical amplifier 301 does not need to include an excitation light source in each of the first amplification fiber 10-1 and the second amplification fiber 10-2, and thus can improve amplification efficiency.

The isolator 22 blocks the remaining excitation light L1 so that the excitation light L1 that has not been used even in the second amplification fiber 10-2 does not leak to the subsequent stage and outputs only the signal light Ls to the subsequent stage. The signal light Ls amplified in each core of the amplification fiber 10 is separated into a C band and an L band by a fan-out (FO) 34 and then multiplexed by the band multiplexer/demultiplexer 35, and is incident on the transmission line 52.

Although the present embodiment has been described using the four-core amplification fiber 10 of FIG. 1, the number of cores of the amplification fiber 10 may be six or more as illustrated in FIG. 2.

### Fourth Embodiment

The amplification fiber 10 may be of a single-mode or multi-mode.

### Fifth Embodiment

Although the optical amplifier of the embodiments described above amplifies two bands of signal light, the number of bands of signal light to be amplified is not limited to two. An optical amplifier that amplifies three or more bands can be formed by varying a total distance from one end to the other end of the amplification fiber 10 in which rare earth ions are doped for each of cores for the different bands. At this time, the cores are disposed such that the cores having the same band are not adjacent to each other, as illustrated in FIG. 2.

Additional Description

Hereinafter, the optical amplifier according to the present embodiment will be described.
(1): The present optical amplifier includes
a first multi-core transmission optical amplification fiber having a first cladding 11a in which 2n (n≥1) cores doped with rare earth ions are disposed and a second cladding (not illustrated) for confining excitation light,
a second optical amplification fiber, of a plurality of optical fibers having 2n cores, connected subsequent to the first amplification fiber in which n C-band amplification cores are non-erbium-doped cores and n L-band amplification cores are erbium-doped cores,
an excitation light generation part that generates excitation light in the amplification fiber,
an excitation light multiplexing part for coupling the excitation light, and
an input part that causes signal light of certain n bands to be incident on n non-adjacent cores of the amplification fiber and causes light having a different band from the signal light that has been incident on the n cores to be incident on the remaining n non-adjacent cores of the amplification fiber.

(2): In the optical amplifier according to (1) described above,

the rare earth doped to the amplification fiber is at least erbium, and the two bands to be amplified are a C-band (1530 to 1565 nm) and an L-band (1565 to 1620 nm).
(3): In the optical amplifier according to (1) or (2) described above,
the n C-band amplification cores and the n L-band amplification cores have a heterogeneous core structure having different refractive index distributions and erbium doping distributions.
(4): In the optical amplifier according to any of (1) to (3) described above,
each core of the first and second amplification fibers has a core structure for realizing propagation in M modes.
(5): In the optical amplifier according to any of (1) to (4) described above,
a multi-core structure with cores disposed such that the cores for having the same band are not adjacent to each other to amplify three or more different bands at the same time.

The present optical amplifier has the following effects and features.

The present optical amplifier contributes to further increasing the density of excitation light by allocating different bands to adjacent cores of the amplification cores and realizes efficient optical amplification by further connecting amplification fibers having different characteristics in a longitudinal manner in a subsequent stage.
The present invention provides a highly efficient optical amplifier. The optical amplifier realizes high capacity transmission over a long distance with less power consumption compared to conventionally used optical amplification techniques.

### REFERENCE SIGNS LIST

10 Amplification fiber
10-1 First amplification fiber
10-2 Second amplification fiber
11a Cladding
11b, 11b-1 to 11b-6 Core
20 Excitation light source
21 Light incidence part
22 Isolator
31 Band multiplexer/demultiplexer
32 Fan-in (FI)
33 Multiplexer
34 Fan-out (FO)
35 Band multiplexer/demultiplexer
51, 52 Transmission line
301 Optical amplifier

1. An amplification fiber that is a multi-core amplification fiber having, from one end to the other end, a plurality of cores in a cladding,
wherein a total distance from the one end to the other end in which rare earth ions are doped differs depending on types of cores.

2. The amplification fiber according to claim 1,
wherein, between the one end and the other end, there is a section in which all of the plurality of cores are not doped with the rare earth ions.

3. The amplification fiber according to claim 1,
wherein a refractive index distribution on a cross section differs depending on the types of cores.

4. The amplification fiber according to claim 1,
wherein a concentration distribution of the rare earth ions on a cross-section of a section where all of the cores are doped with the rare earth ions differs depending on the types of cores.

5. The amplification fiber according to claim 1,
wherein the plurality of cores are disposed such that the cores of a same type are not adjacent to each other.

6. An optical amplifier comprising:
the amplification fiber according to claim 1; and
a light incidence part configured to cause excitation light to be incident on the cladding of the amplification fiber and cause signal light to be incident on the core of the amplification fiber,
wherein the light incidence part causes the signal light to be incident on the core of a different type depending on a band.

7. The optical amplifier according to claim 6, wherein the amplification fiber propagates the signal light in multi-mode.
